(19) United States
(12) Patent Application Publication
(10) Pub. No.: US 2024/0395436 A1
(43) Pub. Date: Nov. 28, 2024

(54) MULTI-ELEMENT ATOM ARRAY

(71) Applicant: The University of Chicago, Chicago, IL (US)

(72) Inventors: Hannes BERNIEN, Chicago, IL (US); Kevin SINGH, Chicago, IL (US); Shraddha ANAND, Chicago, IL (US)

(21) Appl. No.: 18/202,197

(22) Filed: May 25, 2023

(51) Int. Cl. G21K 1/00

(52) U.S. Cl. CPC G21K 1/006

(57) ABSTRACT

A system for generating a multi-element atom array includes a first spatial light modulator that transforms a first input laser beam into a first modulated laser beam and a second spatial light modulator that transforms a second input laser beam into a second modulated laser beam. The first input laser beam has a first wavelength while the second input laser beam has a second wavelength different from the first wavelength. The system includes a beam combiner that combines the first and second modulated laser beams into a combined laser beam. The system includes a lens that focuses the combined laser beam. The first spatial-light modulator is controlled to generate a first array of optical tweezers at the first wavelength for trapping a first atomic element. The second spatial-light modulator is controlled to generate a second array of optical tweezers at the second wavelength for trapping a second atomic element.

### RELATED APPLICATIONS

This application claims priority to U.S. Provisional Patent Application No. 63/365,310, filed on May 25, 2022, the entirety of which is incorporated herein by reference.

### STATEMENT REGARDING FEDERALLY SPONSORED RESEARCH OR DEVELOPMENT

This invention was made with government support under FA9550-21-1-0209 awarded by the Air Force Office of Scientific Research, 2016136 awarded by the National Science Foundation, and N00014-20-1-2510 awarded by the Office of Naval Research. The government has certain rights in the invention.

### BACKGROUND

Quantum processing architectures that include multiple qubit modalities offer high-fidelity operations and readout, quantum error correction, and a path for scaling to large system sizes. Such hybrid architectures have been realized for superconducting circuits and trapped ions.

### SUMMARY

Recently, a new approach for constructing large, coherent quantum processors has emerged based on arrays of individually trapped neutral atoms. However, these demonstrations have been limited to arrays of a single atomic element where the identical nature of the atoms makes crosstalk-free control and non-demolition readout of a large number of atomic qubits challenging. The present embodiments include multi-element atom arrays, including a dual-element atom array with individual control of single rubidium and cesium atoms. We demonstrate their independent placement in arrays with up to 512 trapping sites and observe negligible crosstalk between the two elements. Furthermore, by continuously reloading one atomic element while maintaining an array of the other, we demonstrate a new continuous operation mode for atom arrays without any off-time. Our results enable avenues for ancilla-assisted quantum protocols such as quantum non-demolition measurements and quantum error correction, as well as continuously operating quantum processors and sensors.

In embodiments, a system for generating a multi-element atom array includes a first spatial light modulator that transforms a first input laser beam into a first modulated laser beam and a second spatial light modulator that transforms a second input laser beam into a second modulated laser beam. The first input laser beam has a first wavelength while the second input laser beam has a second wavelength different from the first wavelength. The system includes a beam combiner that combines the first and second modulated laser beams into a combined laser beam. The system includes a lens that focuses the combined laser beam. The first spatial-light modulator is controlled to generate a first array of optical tweezers at the first wavelength for trapping a first atomic element. The second spatial-light modulator is controlled to generate a second array of optical tweezers at the second wavelength for trapping a second atomic element.

### BRIEF DESCRIPTION OF THE FIGURES

FIG. 1 is a diagram of a system for generating a multi-element atom array.

FIG. 2 shows fluorescence images of a dual-element atom array that was generated by the system of FIG. 1.

FIG. 3 shows homogeneity and loading statistics for Rb and Cs arrays.

FIG. 4 illustrates continuous-mode operation of the dual-element atom array of FIG. 2.

FIG. 5 shows fluorescence images of dual-element atom arrays with arbitrary geometries that were generated by the system of FIG. 1.

FIG. 6 shows the experimental sequence that used to load atoms into the dual-element atom array of FIG. 2.

FIG. 7 shows example histograms of the number of fluorescence photons collected by a single Rb atom (top) and a single Cs atom (bottom) during a 40 ms imaging time.

FIG. 8 is a plot of lifetimes of the trapped atoms with continuous laser cooling using polarization-gradient cooling light.

### DETAILED DESCRIPTION

### I. Introduction

Realizing large-scale programmable quantum devices with the capability to simulate the behavior of complex processes in physics and chemistry, and to process large amounts of quantum information with high fidelity is at the forefront of science [1-4]. A central challenge common to all quantum architectures is how to increase system sizes while maintaining high-fidelity control of and low crosstalk between individual qubits. A universal strategy to address this challenge is to employ a hybrid architecture of multiple qubit modalities, where different types of physical qubits perform distinct functions to evade crosstalk and leverage the advantageous properties of each qubit type [5, 6]. For instance, Google's Sycamore quantum processor employs two types of circuit elements made from Josephson junctions for different tasks, with one type used as a set of qubits for processing and the other type used as adjustable couplers to enable low-crosstalk, coherent manipulation of the quantum device [7]. For quantum dots, the nuclear spins of ³¹P donors in silicon have been used as memory qubits with the associated electron spin reserved for processing [8, 9]. Analogously, the electron spin of a single nitrogen-vacancy center can be coupled to neighboring nuclear spin qubits (¹⁴N nuclear spin or ¹³C nuclear spins) which act as quantum memories [10]. In the ion trapping community, two species of ions are often used, where one species acts as an auxiliary logic qubit to enable sympathetic cooling, state initialization, and detection for a nearby spectroscopy ion [11, 12]. Manipulations and measurements of one species of ion using laser beams have negligible effects on the other ion species because the resonant transition wavelengths have substantial separation [5], which can provide, for example, the necessary isolation between memory ions and ions coupled with photonic interfaces needed for the development of scalable ion trap quantum networks [13].

Recently, neutral atom arrays have emerged as a promising quantum architecture for pushing the current limits on system sizes [14, 15], coherence [16], and high-fidelity state preparation and control [17-21]. In these systems, individual neutral atoms are trapped in arrays of optical tweezers and coherent interactions between atoms are generated by exciting them to Rydberg states. Atom array experiments have reached system sizes of hundreds of atoms [14, 15, 22], and recent demonstrations of programmable quantum simulations [23-25] and high-fidelity gate operations [17-19] exemplify the potential of this platform.

Despite the impressive progress, demonstrations of neutral atom arrays have thus far been limited to single atomic elements, which possess fundamental challenges for readout and control. In particular, the slow and destructive fluorescence-based readout of identical atomic qubits makes it difficult to perform quantum non-demolition (QND) detection, a requirement for quantum error correction, without loss of the qubit state and without nearby atoms absorbing the scattered fluorescence and thereby decohering their quantum states [26]. With respect to control, quantum protocols must be halted due to resonant light-scattering and light-assisted atomic collisions when restoring atoms after they have been depleted from the array. These challenges can be overcome by introducing a second atomic element with vastly different transition frequencies into the atom array [21], opening up new hybrid degrees of freedom that can be leveraged to expand and improve control over the quantum system [11]. However, neutral atom array architectures with multiple qubit elements have yet to be realized.

In embodiments, a dual-element, two-dimensional (2D) atom array is constructed from individual rubidium (Rb) and cesium (Cs) atoms trapped in up to 512 optical tweezers. The choice of Rb and Cs atoms enables independent loading, cooling, control, and measurement in the array. This independent control allows Rb and Cs atoms to be loaded simultaneously into arbitrary 2D array geometries. For instance, we generate arrays where Rb is interleaved within the Cs array in a geometry suitable for surface code operations and stabilizer measurements [27, 28]. Moreover, we find that it is possible to load one atomic element into the tweezers while maintaining an array of the other element with no additional losses. This enables the continuous operation of an atomic array without any measurement down-time due to atom loading and initialization, a feature that is inaccessible in single-species atom arrays.

A dual-element array has been a long-sought-after architecture for a myriad of quantum protocols, including quantum sensing assisted by auxiliary qubits [29], quantum error-correction [27], quantum state manipulation over long time-scales [21], and quantum simulation [30]. The present embodiments can be used to for continuous operation of atom array-based quantum processors and sensors.

### II. Multi-Element Atom Array

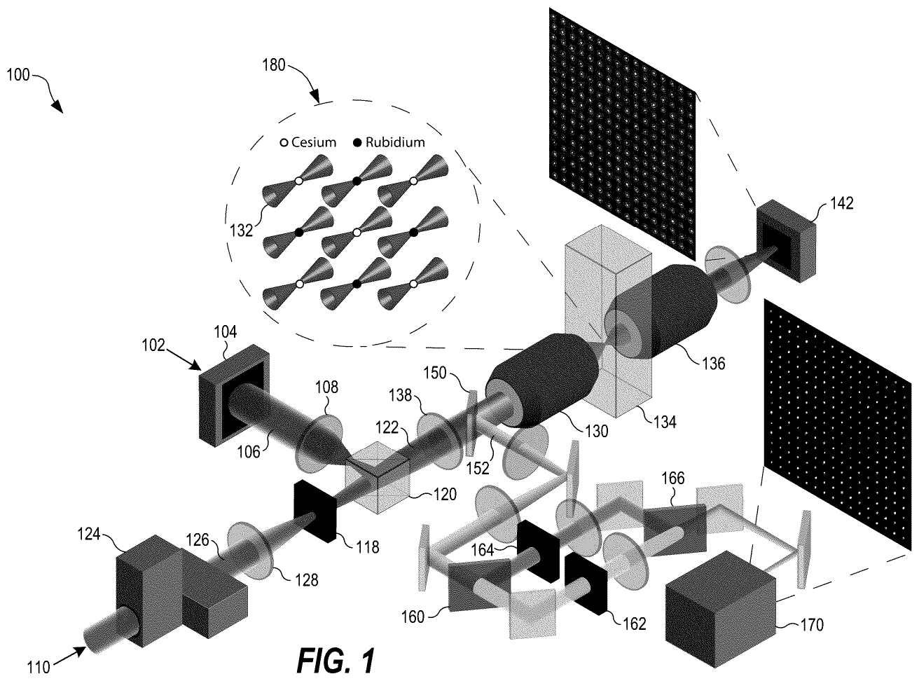

FIG. 1 is a diagram of a system 100 for generating a multi-element atom array, in accordance with the present embodiments. The system 100 includes a first spatial light modulator 104 that spatially modulates a first input laser beam 102 into a first modulated laser beam 106. The system 100 also includes a second spatial light modulator 124 that spatially modulates a second input laser beam 122 into a second modulated laser beam 126. The system 100 also includes a beam computer 120 that combines the modulated laser beams 106 and 126 into a combined laser beam 122. The system 100 also includes a lens 130 that focuses the combined laser beam 122 to generate a dual-wavelength optical tweezer array 180 inside of a vacuum cell 134.

The first input laser beam 102 has a first wavelength λ₁ selected to optically trap atoms of a first atomic element. The second input laser beam 122 has a second wavelength λ₂, different from the first wavelength λ₁, selected to optically trap atoms of a second atomic element that is different than the first atomic element. For example, the first atomic element may be rubidium and the second atomic element may be cesium. In this case, the first wavelength λ₁ may be red-detuned with respect to the D₁ transition of rubidium near 795 nm. The second wavelength λ₂ may be red-detuned with respect to the same transition in cesium, which has a wavelength near 894 nm. In both cases, each optical tweezer 132 in the array 180 occurs at a point where the laser intensity is a local maximum. Due to the coupling between the atoms and the laser field, this local maximum acts a three-dimensional potential minimum, or trap, for the atoms. For an atom to be confined within a trap, its temperature must be less than the trap depth of the optical tweezer 132. For clarity in FIG. 1, only one of the optical tweezers 132 is labeled.

In general, the first and second atomic elements may be any atomic species that can be cooled (e.g., via laser cooling, evaporative cooling, sympathetic cooling, etc.) and optically trapped. The most common of these atomic species are the alkali metals (e.g., lithium, sodium, potassium, rubidium, cesium, etc.). However, several alkaline-earth metals (e.g., magnesium, calcium, strontium, ytterbium, etc.) and noble gases (e.g., helium, neon, xenon, etc.) can also be cooled and optically trapped, and therefore can be used with the present embodiments.

Each of the spatial light modulators 104 and 124 may be any type of device capable of spatially modifying or modulating a laser beam, either in transmission or reflection. Examples include, but are not limited to, a single acousto-optic deflector that deflects a laser beam in one direction, a pair of crossed acousto-optic deflectors that deflects a laser beam in two directions, a transmissive or reflective liquid-crystal modulator, a phase plate, and a digital micromirror device. Regardless of type, the spatial light modulators 104 and 124 ideally operate at or near the wavelengths λ₁ and λ₂, respectively. For example, the first spatial light modulator 104 may be anti-reflection coated to enhance transmission of light at the first wavelength λ₁. The second spatial light modulator 124 may be similarly anti-reflection coated.

In the example of FIG. 1, the beam combiner 120 is a broadband polarized beamsplitter cube. In this case, the modulated laser beams 106 and 126 have orthogonal linear polarizations. If needed, a retarder (e.g., a λ/4 waveplate or λ/2 waveplate) may be used to change the polarization of one of the modulated laser beams 106 and 126. However, the beam combiner 120 may be another optical component that combines two (or more) laser beams at different wavelengths. For example, the beam combiner 120 may be a non-polarized beamsplitter, in which case the modulated laser beams 106 and 126 may have any polarization. Alternatively, the beam combiner 120 may be a dichroic mirror (e.g., a hot mirror or cold mirror) designed to transmit (or reflect) light at the first wavelength λ₁ and reflect (or transmit) light at the second wavelength λ₂.

To generate tightly focused optical tweezers that form deep atom traps, the lens 130 may have a high numerical aperature (e.g., 0.5 or more). The lens 130 may be, for example, a microscope objective, spherical lens, aspherical lens, or any other type of single-element or multi-element lens or lens system. The lens 130 may be corrected for chromatic aberration at the wavelengths λ₁ and λ₂. To reduce optical loss and minimize reflections, the lens 130 may be anti-reflection coated at one or both of the wavelengths λ₁ and λ₂. In one embodiment, the lens 130 is a microscope objective corrected for the glass wall of the vacuum cell 134.

In certain embodiments, the system 100 includes various lens for transforming one or both of the modulated laser beams 106 and 128. For example, in FIG. 1, the system 100 includes lenses 108 and 132 that magnify the first modulated laser beam 106 by a first magnification factor M₁. The system 100 also includes a lens 128 that cooperates with the len 132 to magnify the second modulated laser beam 126 by a second magnification factor M₂. The magnification factors M₁ and M₂ are selected such that the modulated laser beams 106 and 126 fully overlap each other after the lens 132. As an alternative to the setup shown in FIG. 1, the first modulated laser beam 106 may be magnified using a telescope that is placed before the beam combiner 120. The same is true for the second modulated laser beam 126.

Although not shown in FIG. 1, the system 100 may include a first controller configured to control the first spatial light modulator 104 such that the first modulated laser beam 106, after being focused by the lens 130, forms a first plurality of optical tweezers (e.g., see the optical tweezers 132 in FIG. 1 that are trapping cesium atoms). The system 100 may also include a second controller configured to control the second spatial light modulator 124 such that the second modulated laser beam 126, after being focused by the lens 130, forms a second plurality of optical tweezers that do not spatially overlap the first plurality of optical tweezers (e.g., see the optical tweezers 132 in FIG. 1 that are trapping rubidium atoms).

We used a prototype of the system 100 of FIG. 1 to demonstrate the generation of the dual-wavelength optical tweezer array 180. We also used the prototype to demonstrate loading and trapping individual atoms from a laser-cooled cloud of Rb and Cs atoms into the tweezer array 180. This optical tweezer array 180 was formed by combining a 2D array of tweezers at λ₁=910 nm generated from a spatial-light modulator (SLM) and a separate 2D array of tweezers at λ₂=811 nm generated from an acousto-optic deflector (AOD). Both the AOD and SLM are equally suitable for generating trapping arrays for either element for the tweezer separations of several microns used in our experiment, which correspond to the interaction range for typical Rydberg states [31]. The wavelengths and laser intensities are chosen such that the 910 nm tweezers and the 811 nm tweezers are element-selective for single Cs and Rb atoms, respectively [32]. Control of the phase pattern on the SLM and of the radio-frequency (RF) tones sent to the AOD enables flexible arrangement of the positions of each optical tweezer, allowing us to create arbitrary 2D geometries of Rb and Cs atoms. We detect and resolve individual atoms through a high-NA microscope objective via fluorescence imaging.

The particular embodiment shown in FIG. 1 is configured for trapping and imaging two-dimensional, dual-element arrays of neutral atoms. In one embodiment, a spatial filter 118 is used with the second modulated laser beam 126 to mask traps selectively and generate desired geometries. Alternatively, the spatial filter 118 may be used with the first modulated laser beam 106. The AOD and SLM trapping arrays are then combined using a polarized beamsplitter cube as the beam combiner 120. These combined traps propagate along a shared beam path (see the combined laser beam 122) and are focused by a glass-corrected high-numerical-aperture microscope objective (see the lens 130) with NA=0.65 into the vacuum cell 134, thereby creating arbitrary array geometries. The geometry shown in FIG. 1 is a surface-code-inspired geometry with two interleaved arrays.

In certain embodiments, atomic fluorescence (e.g., at 780 nm for Rb and 852 nm for Cs) is collected from the trapped atoms using the lens 130. A custom dichroic mirror 150 located between the beam combiner 120 and lens 130 reflect the atomic fluorescence along a fluorescence beam path 152 toward an electron-multiplying CCD (EMCCD) camera 170. The signal-to-background ratio may be improved by separating the fluorescence, based on wavelength, before the EMCCD (see dichroic mirrors 160 and 166 in FIG. 1) and performing individual spatial filtering (see spatial filters 162 and 164 in FIG. 1).

The dual-wavelength optical tweezer array 180 is imaged through a lens 136 onto a CCD camera 142 to both enable feedback-based intensity homogenization and confirm the relative alignment of the two 2D tweezer arrays. The focus of the Cs optical tweezers can be brought into the same plane as the Rb optical tweezers by modifying the phase pattern on the SLM. In FIG. 1, the lens 136 is a microscope objective. However, the lens 136 may be a different type of lens without departing from the scope hereof.

In some embodiments, the system 100 further includes the vacuum cell 134. One or more walls the vacuum cell 134 may be anti-reflection coated at the first wavelength λ₁, the second wavelength λ₂, the fluorescence wavelength of the first atomic species, the fluorescence wavelength of the second species, or any combination thereof (e.g., a broadband anti-reflection coating covering all of these wavelengths). The vacuum cell 134 may alternatively be a conventional vacuum chamber with viewports or windows.

In some embodiments, the system includes a first laser used to generate the first input laser beam 102, a second laser used to generate the second input laser beam 122, or both. In other embodiments, one or both of the first and second lasers is provided by a third party.

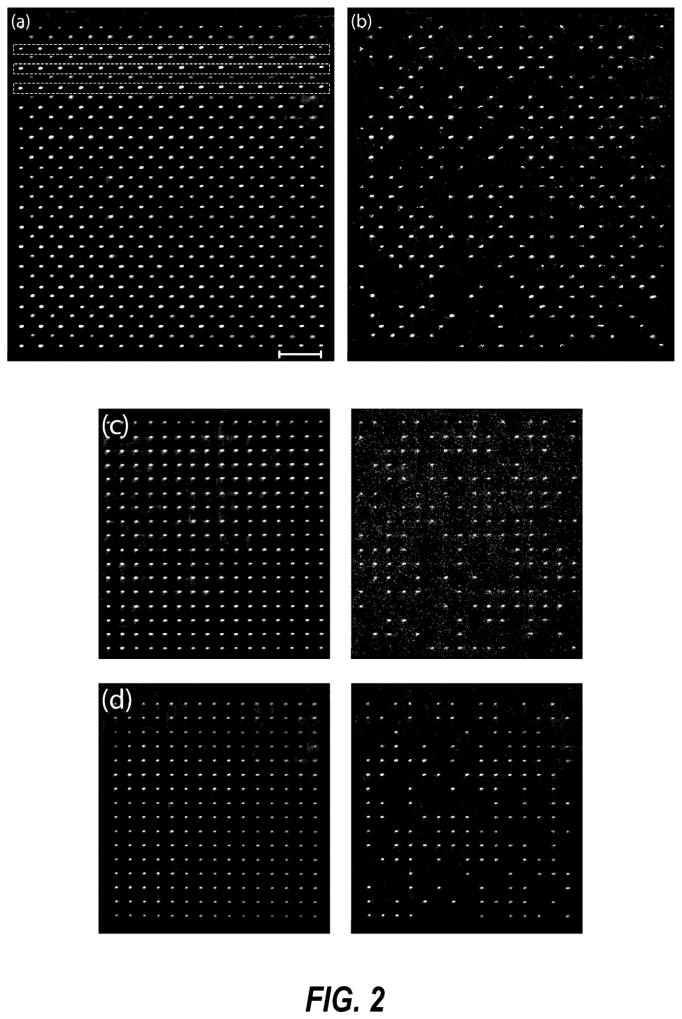

While FIG. 2 shows the system 100 generating the dual-wavelength optical tweezer array 180 for trapping two different atomic elements, the present embodiments include systems that generate optical tweezers at more than two wavelengths for trapping more than two different atomic elements. For example, the system 100 may include a third spatial light modulator that modulates a third input laser beam into a third modulated laser beam. In this case, the system 100 may include additional optics, as needed, to combine the three modulated laser beams.

As a first experimental demonstration of dual-element loading, we interweaved the 16×15 Rb tweezer array within the 17×16 Cs tweezer array to form a 512-site dual-element atom array in which each Rb atom is placed at the center of four Cs atoms on a 2D lattice. After loading the dual-element atom array from a dual-element magneto-optical trap (MOT), we took separate subsequent fluorescence images of the Rb and Cs atoms in the tweezers (see Section VIII below for a more detailed description of the experimental sequence).

FIG. 2 shows fluorescence images of the dual-element atom array generated by the system 100 of FIG. 1. In FIG. 2, panels (a) and (b) are averaged and single-shot fluorescence images, respectively, of Rb and Cs atoms that are simultaneously loaded in the dual-element atom array. The scale bar in panel (a) indicates a distance of 20 μm. For clarity in panel (a), the third, fifth, and seventh rows of atoms from the top of the image are enclosed in white dashed-line boxes. These enclosed atoms are Cs atoms while non-enclosed atoms in the second, fourth, sixth, and eighth rows are Rb atoms. It should be understood that this alternating sequence of rows of Cs and Rb atoms continues throughout the images in panels (a) and (b).

Panel (c) of FIG. 2 shows example averaged (left) and single-shot (right) images for only the 17×16 Cs tweezer array. Panel (d) of FIG. 2 shows example averaged (left) and single-shot (right) images for only the 16×15 Rb tweezer array.

As demonstrated in all of the images of FIG. 2, each atom site is spatially resolved, enabling single-shot single-atom detection of both elements. More details about the imagine sequence, parameters, and fluorescence histograms can be found in Sections VII and VIII below.

### III. Homogeneous Arrays and Independent Loading

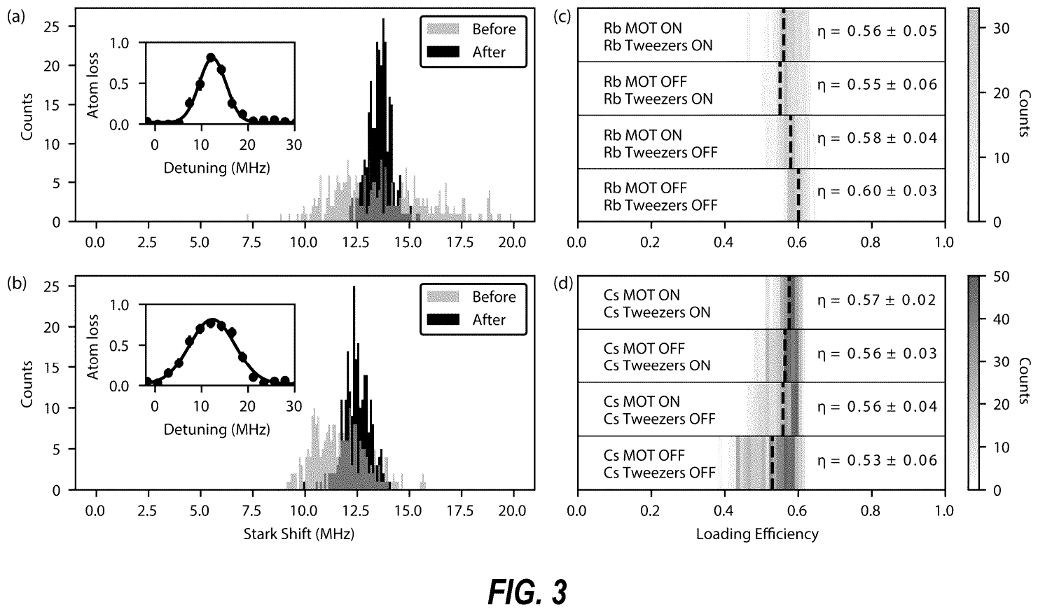

To obtain uniform loading across the entire optical tweezer array, it is necessary to homogenize the intensity of the trapping potentials experienced by the atoms. To achieve this, we perform feedback on the amplitude of the RF tones used to generate the Rb tweezers and the phase pattern used to generate the Cs tweezers. As a first step, we use the CCD to homogenize the intensities of each tweezer array to within 2%. As a second step we directly use the energy shift experienced by the atoms for a more accurate measurement of the tweezer intensities. These energy shifts, called Stark shifts, are shown for Cs and Rb by the grey histograms in panels (a) and (b), respectively, of FIG. 3. For the AOD, we use these measured Stark shifts to weight the amplitude of the RF tones to further homogenize the tweezer intensities. For the SLM, we use the weighted Gerchberg-Saxton algorithm and replace the target amplitudes with the measured Stark shift values to perform the feedback. The final Stark shifts for Cs and Rb are shown by the black histograms in panels (a) and (b), respectively, of FIG. 3. The uniformity is 4% rms.

We next examine how the loading of the Rb and Cs atoms is affected by the presence of the other atoms' MOT and tweezer array. In general, one expects inter-species collisional interactions and light-scattering between MOTs of different species. In our experiment, the large wavelength separation between the laser-cooling transitions at 780 nm (Rb) and 852 nm (Cs) results in a negligible photon-scattering rate for each element with respect to the other element's laser-cooling light. Additionally, the probability of collisional interactions between the two elements within the tweezers is suppressed because the Cs tweezers are too weak to confine the Rb atoms and the Rb tweezers form anti-trapping potentials for the Cs atoms [34, 35]. Panels (c) and (d) of FIG. 3 show histograms of the loading efficiency of each tweezer array with and without the presence of the other atoms' MOT and with and without the presence of the other atoms' tweezer array. The Rb tweezers form large-scale anti-trapping potentials through the Cs MOT that affect cooling of the Cs atoms into the tweezers, broadening the Cs loading efficiency. We find that regardless of the various interaction effects that may occur between the two MOTs and the presence of the dual-array trapping potentials, the average loading efficiency in each tweezer array remains stable and higher than 50%, in agreement with values measured in single-element arrays operating in the collisional blockade regime [36].

FIG. 3 shows homogeneity and loading statistics for Rb and Cs arrays. Panel (a) shows Stark shifts across a 17×16 Cs array before (gray) and after (black) trap intensity correction via the weighted Gerchberg-Saxton algorithm based on feedback from the atoms. The inset provides an example Stark shift measurement in which the frequency of a pushout beam is swept to determine the trap-induced ac Stark shift. Panel (b) shows Stark shifts across a 16×15 Rb array before (gray) and after (black) trap intensity correction via the optimization of the rf tones driving the AODs based on feedback from the atoms. The inset provides an example Stark shift measurement. Panel (c) shows loading statistics for the Cs array with and without the presence of the Rb MOT and Rb tweezers. The dashed lines indicate the average loading efficiencies. The reported loading efficiency errors are the standard deviations of their respective distributions. Panel (d) shows loading statistics for the Rb array with and without the presence of the Cs MOT and Cs tweezers. The dashed lines indicate the average loading efficiencies.

### IV. Continuous-Mode Operation

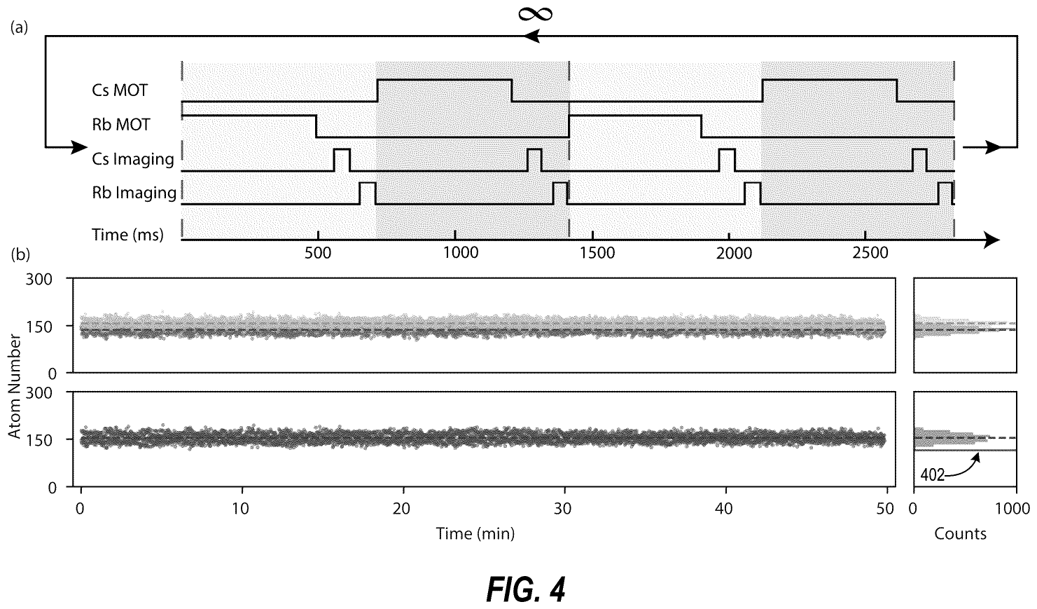

The observation that Rb and Cs atoms can be simultaneously loaded into their respective arrays with high efficiency opens up the possibility of loading one of the elements into the tweezer array while holding the other. We investigate this capability with the experimental sequence shown in panel (a) of FIG. 4. Here, we continuously alternate which element we load into the optical tweezer array while holding the other. This involves rebuilding a Rb (Cs) MOT while Cs (Rb) atoms are still trapped in the tweezer array. We measure the occupation of each optical tweezer by taking fluorescence images of the Rb and Cs atoms before and after each MOT formation. This procedure allows us to deduce the number of atoms lost due to rebuilding the array of the other atomic element. Remarkably, we observe no additional losses of the held atoms when the other atomic element is loaded in this time period (see Section VIII for more details).

This independent reloading capability allows us to operate the atom array in a continuous mode, as demonstrated in panel (b) of FIG. 4. Here, we repeat the sequence shown in panel (a) of FIG. 4 for 50 minutes. Due to the large separation of energy levels between Rb and Cs, photon scattering of one element from the other element's MOT lasers is negligible; using our experimental parameters during MOT formation, the scattering rate for Rb atoms from the Cs MOT lasers is 2.5×10⁻⁷ photons/s and the scattering rate for Cs atoms from the Rb MOT lasers is 2.4×10⁻⁷ photons/s. While one element loads into the array, the other element remains idle and available for quantum experiments due to this negligible photon scattering. By alternating between the elements, we continuously have more than 115 atoms trapped within the tweezer array available for manipulation or computation. We refer to these atoms as data atoms and plot their atom number as a function of time in the bottom of panel (b) of FIG. 4. In the context of single-element tweezer arrays, reservoirs of atoms have been used to fill in defects in atom arrays or proposed to fill in and re-initialize lost atoms during a computation [21]. Operation of the atom array ceases once the reservoir is depleted and only continues once the whole array and the reservoir are reloaded. In our dual-element continuous-mode operation, the newly loaded atoms would not be used to fill in gaps in the array of the other atomic element but rather to continue measurement of a physical quantity or to swap qubit states of the old array into the newly loaded array using Rydberg interaction gates in a manner similar to a “quantum” baton pass. Neither of these applications would be available for single-element atom arrays because of near-resonant light-scattering and light-assisted collisions during the reloading of the MOT.

FIG. 4 illustrates continuous-mode operation of the dual-element atom array shown in FIG. 2. In FIG. 4, panel (a) shows the pulse sequence used to reload the Rb atoms and Cs atoms into the atom array. Rb (Cs) atoms are reloaded into the array while the Cs (Rb) atoms are held in their optical tweezers. The shaded regions, light gray for Cs and dark gray for Rb, indicate the atomic element available for manipulation or computation during the specified time window. By performing the pulse sequence repeatedly, a continuously available atomic array can be maintained. Panel (b) of FIG. 4 shows the number of Rb (dark gray) and Cs (light gray) atoms in each image from a 50-minute data run. The dashed lines indicate the average atom counts. The number of atoms available for manipulation as a function of time indicates that the atom array continuously operates with over 115 atoms (see line 402) at any moment in time.

### V. Arbitrary Geometries

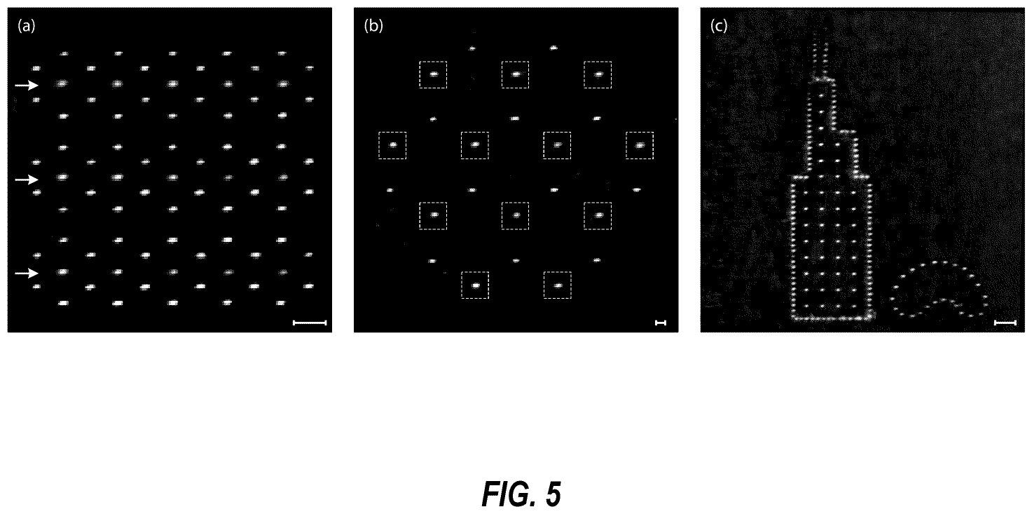

FIG. 5 shows dual-element atom arrays with arbitrary geometries that were generated by the system 100 of FIG. 1. Specifically, panel (a) of FIG. 5 is an averaged fluorescence image of a Rb-dressed Cs hexagonal array in which each Rb atom (identified by white arrows) is surrounded by a hexagon of Cs atoms. Panel (b) of FIG. 5 is an average fluorescence image of a bipartite honeycomb lattice in which each Rb atoms is surrounded by a white dashed-line box. Panel (c) of FIG. 5 is an averaged fluorescence image of two famous Chicago landmarks: the Willis Tower (formerly the Sears Tower) and The Bean (Cloud Gate). In panel (c), the atoms forming the center of the Willis Tower are Rb atoms; all others are Cs atoms. In all of FIG. 5, the scale bars indicate 10 μm.

While the SLM can directly generate arbitrary trapping arrays, the arrays shown in FIG. 5 were built by combining the regularly spaced trapping arrays of the AOD with spatial filtering to block specific traps and generate the desired geometries. These results highlight this platform's capability of placing Rb and Cs atoms in arbitrary geometries with respect to one another, a critical ingredient for engineering qubit interactions and simulating complex models in quantum many-body physics. Additionally, the two arrays can be controllably separated along the out-of-plane dimension by modifying phase pattern on the SLM, opening up research avenues for increasing qubit connectivity, for the study of strongly correlated matter in three spatial dimensions, and for simulating Abelian lattice gauge theories [38].

### VI. Outlook

This platform is the first demonstration of dual elements in an atom array experiment and reveals that we retain independent control of the loading, cooling, and imaging of each atomic element. This independent control enables the positioning of single Rb and Cs atoms into arbitrary structures with respect to one another, allowing us to engineer atomic qubit geometries that have important applications in quantum information processing and quantum simulation of complex problems in many-body physics. Additionally, our observation that an atom array can be operated in a continuous mode opens up exciting opportunities in quantum sensing and continuous qubit manipulation. It will be necessary to investigate the coherence of quantum states in one atomic element while the other atomic element is being loaded into the array. Encouragingly, the negligible off-resonant excitation due to the large frequency separation of 2π×32.5 THz and recent results on the coherence in optical tweezers suggest that coherent manipulation of atomic qubits throughout successive atom loading events is achievable.

Our independent two-element architecture opens up pathways to perform quantum non-demolition measurements and evade crosstalk in neutral atom arrays [21]. While this crosstalk can be mitigated using dual-species arrays formed by different isotopes of the same element [40], a dual-element platform benefits from a substantial wavelength separation of atomic resonances [5, 21], species-specific trapping potentials [32, 41], and crosstalk free mutual tunability of homonuclear and heteronuclear Rydberg-Rydberg interactions that are important for scaling neutral atom arrays to larger system sizes. With the same atom separations shown in FIG. 2, quantum gates using Rydberg interactions can be used to entangle the qubit states from one element serving as a ‘data’ qubit with another element serving as an ‘auxiliary’ qubit, which can then be detected without added perturbations of the ‘data’ qubits. This Rydberg gate can also be used to entangle a single ‘auxiliary’ qubit with a large number of ‘data’ qubits in a single step [42]. For these applications, it may be beneficially to deterministically load the atoms without defects using standard rearrangement techniques [14, 37, 43, 44]. Due to the geometry of our 512-site dual-element atom array, simultaneous row and column rearrangements of the Rb and Cs atoms naturally avoid collisions with one another, thereby enabling efficient rearrangement movements. By incorporating a second SLM into the setup, we plan to implement 2D rearrangement protocols by using the two SLMs to generate permanent optical tweezers for each element and the AOD to perform simultaneous rearrangement of both elements. Moreover, system sizes can be increased with additional laser power while remaining within the 300-micron field-of-view of our microscope objective.

With respect to interactions, Rydberg-excitation lasers can be used to either uniformly illuminate the entire array from the side of the glass cell to generate long-range interactions or, with an addition of an SLM or multi-channel AOD, perform site-specific entangling gate operations through the second microscope objective shown in FIG. 1. Furthermore, one can use Förster resonances between the Rb—Rb, Cs—Cs, and Rb—Cs atoms to tune the strength of interactions between any pair of atoms to be weak or strong with respect to one another. Theoretical studies of Forster resonances in interspecies Rydberg-Rydberg interactions for Rb and Cs have already been performed and provide pathways for accessing interaction regimes where the intraspecies and interspecies interactions strengths can be controlled independently by tuning the Rydberg excitation level and the trap geometries. Due to the large separation of energy levels between Rb and Cs, the interspecies and intraspecies Rydberg interactions can be controlled independently and without crosstalk using different sets of excitation lasers for each atom.

Rydberg excitation and coherent manipulation of atomic qubits are now standard techniques among single-element array technologies and we anticipate no major roadblocks in extending these techniques simultaneously to two elements due to: 1) the large difference in atomic resonances between Rb and Cs which reduces crosstalk and 2) our ability to independently trap and load both elements into a large array. The wide tunability of asymmetric Rydberg interaction strengths between the two elements enables the exploration of new methods of large-scale multi-qubit manipulation and control, allowing, for example, interactions between one species of atoms to be mediated by the other. Accordingly, several proposals suggest that dual-element architectures using Rb and Cs qubits are well-suited for developing a neutral atom-based coherent quantum

annealer and for fault-tolerant quantum computation with Rydberg atoms [26]. These dual-element features make our platform an excellent starting point for quantum sensing assisted by auxiliary qubits and quantum error correction in neutral atom arrays [27].

### VI. Summary of Apparatus

### 2D and 3D MOTs

The Rb and the Cs atoms were released from two alkali-metal dispensers placed inside a dual-source glass cell (ColdQuanta). These atoms were cooled in a retro-reflected bichromatic 2D magneto-optical trap (MOT) operating at both 780 and 852 nm. A bichromatic push-beam transferred the atoms through a pinhole into a separate ultrahigh-vacuum glass cell (JapanCell), where a dual-element 3D MOT was used to trap and further cool the atoms. An ion pump (NEXTorr D500-5) maintained vacuum in the ultrahigh-vacuum glass cell with a measured background pressure less than 10⁻¹¹ Torr.

The MOT beams for both elements shared the same beam paths and were generated by two distributed Bragg reflector (DBR) laser modules (Vescent Photonics) at 780 nm (Rb) and 852 nm (Cs). For the Rb (Cs) 3D MOT, the cycler beams were red-detuned by 12.9 MHz from the free space F=2→F′=3 (F=4→F′=5) D₂ transition while the repump beams were nearly resonant with the free-space F=1→F′=2 (F=3→F′=4) D₂ transition. For both elements, the MOT beam cycler powers were set to the saturation intensities for the relevant transitions with the associated repump power at 10% of the corresponding cycler power. Both atomic elements were loaded into the optical tweezers with the 3D-MOT field gradient set to ˜18 G/cm. The 3D-MOT beam sizes were irised down to a ˜2 mm diameter to minimize stray reflections from the vacuum chamber during imaging.

### Dual-Element 2D Optical Tweezer Arrays

The trapping light for Rb and Cs was generated separately by two Ti: Sapphire lasers (MSquared) set to 811 nm and 910 nm, respectively. The optical tweezer array for the Rb atoms was generated by passing 811-nm light through a pair of crossed acousto-optic deflectors (AA Opto Electronic) controlled with RF tones generated by an arbitrary waveform generator (Spectrum). An SLM (Holoeye) imprinted a computer-generated hologram on the 910-nm laser light to generate the tweezer array for the Cs atoms. For the AOD traps, we observed heating effects between neighboring traps when the difference between RF tones that generate neighboring traps was less than ˜500 kHz, setting our minimum distance to ˜1 μm. For the SLM traps, we observed interference effects across the array that generated aberrations that could not be completely corrected when the trap spacing was below ˜2 μm. Because we operated at distances above 2 μm, both the AOD and SLM are equally suitable for generating trapping arrays for either element.

A high numerical aperture microscope objective (Special Optics) with NA=0.65 was used to tightly focus the tweezers down to Gaussian waists of ˜0.8 μm within the spatial region of the 3D MOTs. After passing through this objective, each individual optical tweezer had an optical power of ˜1 mW. Using release and recapture measurement of the atoms [45], the Rb atoms were measured to have radial trap frequencies of ωᵣ=2π×100 kHz in the 811-nm array, and the Cs atoms were measured to have radial trap frequencies of ωᵣ=2π×60 kHz in the 910-nm array. Via comparison with Monte Carlo simulations, we measured the temperature of the Rb atoms in the optical tweezers to be 50 μK and the temperature of the Cs atoms to be 30 μK at our given optical tweezer intensities. These temperatures can be lowered to a few microkelvin via adiabatic cooling by lowering the depth of the trapping potentials [46].

To homogenize the trap depths, we performed feedback on the intensities measured by a CCD camera and on the Stark shift measurements on the atoms. For the Rb tweezers, this feedback was implemented by controlling the amplitude of the RF tones sent to the AOD [37]. For the Cs tweezers, the feedback was implemented by controlling the target amplitudes in the weighted Gerchberg-Saxton algorithm used to generate the Cs tweezers. Here, we also corrected for optical aberrations by scanning and correcting for low-order Zernike polynomials to maximize the measured intensity in the center of the tweezers [14].

### VIII. Experimental Sequence

### Simultaneous Loading of Rubidium and Cesium

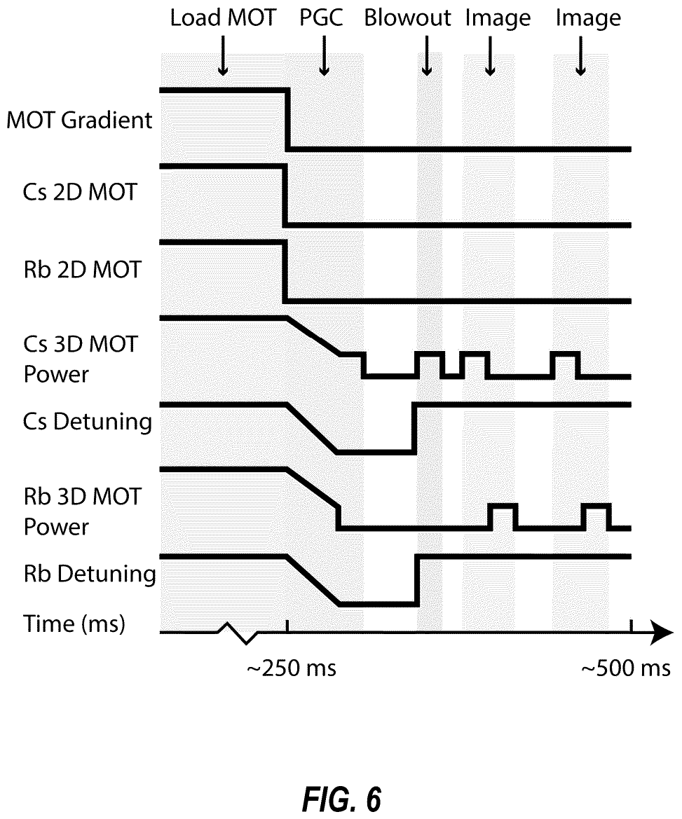

FIG. 6 shows the experimental sequence that used to load atoms into the dual-element atom array of FIG. 2, in accordance with the present embodiments. The dual-wavelength optical tweezer array (811 and 910 nm laser light) remains on during the duration of the experiment. Laser cooling of thermal ⁸⁷Rb and ¹³³Cs atoms begins by turning on the 2D and 3D MOT laser light for ˜300 ms. After loading the atoms in the MOT, the magnetic field gradient is extinguished, and the atoms are cooled below the Doppler temperature limit via polarization-gradient cooling (PGC) in 20 ms by lowering the MOT laser intensities and detunings. The laser cooling light is then turned off for 10 ms to allow untrapped atoms to disperse. We find that the SLM-generated tweezer array also includes spurious, out-of-plane traps. We remove any Cs atoms that may be weakly trapped at these sites by applying a weak, nearly-resonant blowout pulse at 852 nm.

We image the atoms held within the optical tweezers by turning on the 3D MOT beams and collecting the scattered photons from each atom with our microscope objective. The atoms are detected by taking subsequent fluorescence images of the trapped Cs and Rb atoms at 852 nm and 780 nm, respectively. Fluorescence is separated from the trapping light by a multi-edge dichroic (Laser Zentrum Hannover e. V.) and is collected for a period of 40 ms for each image on an EMCCD (Andor IXON 888) camera to perform single-site detection of each atom. Two sets of fluorescence images of the Rb and Cs atoms are then taken to measure loading statistics and atom losses. We remove the scattered background light in the images by separating the two imaging wavelengths using a dichroic and performing spatial filtering in the back focal plane of the microscope objective.

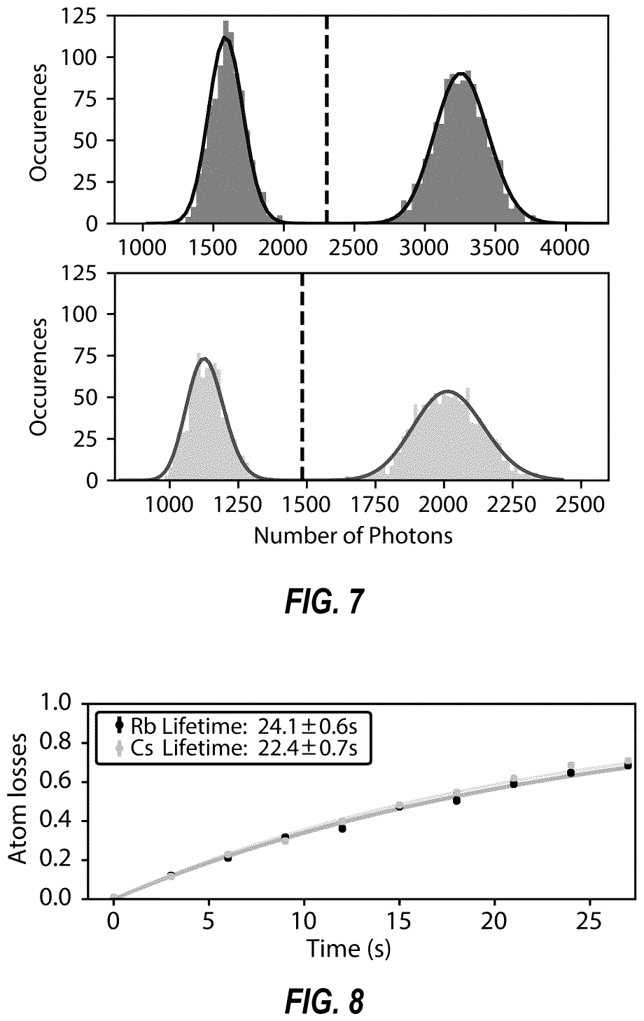

FIG. 7 shows example histograms of the number of fluorescence photons collected by a single Rb atom (top) and a single Cs atom (bottom) during a 40 ms imaging time. In each histogram, the left peak indicates the number of photons collected when an atom is not present, and the right peak indicates the number of photons collected when an atom is present. The presence of atoms is calculated by fitting these histograms to bi-modal distributions and placing threshold (see dashed lines) between the peaks. Using this information, we extract all relevant statistical quantities such as site-wise loading efficiencies and losses. All error bars presented in this analysis are the Clopper-Pearson intervals for that parameter. We never observe Rb atoms in the location of the Cs tweezers (and vice versa).

### Losses During Continuous-Mode Operation

For the experimental sequence in panel (a) of FIG. 4, we use an extended 500-ms MOT formation time to make our measurement more sensitive to atom losses arising from the rebuilding of the other element's MOT. The average loss rates between successive images, with the MOT reload of the other element occurring between images, were measured to be 0.095±0.013 for Rb and 0.104±0.032 for Cs. For the same experimental sequence, we turn off the 2D MOT and 3D MOT for one element to set the baseline loss rate of the other atom. We measure that the baseline Rb loss rate without the presence of the Cs atoms is 0.093±0.020 and the baseline Cs loss rate without the presence of the Rb atoms is 0.109±0.032. In practice, the baseline loss rate can be reduced to values less than a percent by using MOT load times of tens of milliseconds.

### Coherence During Continuous-Mode Operation

To continue the measurement of a physical quantity or to swap the qubit states of an old array into a newly loaded array, the atomic qubits of one element must remain coherent through the reloading process of the other element's MOT.

After loading each element, the trap depths can be lowered from their initial values (˜1 mK) to reduce the effects of dephasing due to AC stark shifts, lower the temperatures of the atoms via adiabatic cooling, reduce the scattering rate from the tweezers, and make the Cs traps more selective (less likely to load Rb atoms). After this power reduction, the Rb traps would remain repulsive for Cs atoms. When reloading, the tweezers for that element would be ramped up again prior to MOT formation to increase loading efficiency. Quantum transfers between the elements would be performed between the formation of the MOTs when the trap depths for both elements are low.

Additionally, the time between transfers of quantum information from one element to the other can be reduced to a time scale much shorter than the reported decoherence times of atomic qubits. The dominant time scale between quantum transfers is the MOT loading time. For the data in FIG. 4, we use a 500-ms MOT formation time to make our experiment more sensitive to atom losses during reloading. In practice, the MOT can be loaded in tens of milliseconds which sets the time needed between quantum transfers to much shorter than the qubit decoherence time of ˜300 ms reported in using a CPMG decoupling sequence and ˜900 ms reported in using magic-intensity dipole traps. The techniques used in these works are compatible with the continuous-mode operation. Furthermore, reducing the MOT loading time would significantly reduce the atom losses during continuous-mode operation.

### Trap Lifetimes

FIG. 8 is a plot of lifetimes of the trapped atoms with continuous laser cooling using the PGC light. Solid lines indicate exponential fits to the data. Error bars are smaller than the size of the markers. This lifetime is limited by background gas collisions in the vacuum chamber and can be improved, for example, with higher vacuum [48] or with a cryogenic environment [49].

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

### REFERENCES

[1] R. P. Feynman, Simulating Physics with Computers, Int. J. Theor. Phys. 21, 467 (1982).
[2] J. Preskill, Quantum Computing in the NISQ Era and Beyond, Quantum 2, 79 (2018).
[3] Y. Alexeev et al., Quantum Computer Systems for Scientific Discovery, PRX Quantum 2, 017001 (2021).
[4] E. Altman et al., Quantum Simulators: Architectures and Opportunities, PRX Quantum 2, 017003 (2021).
[5] T. R. Tan, J. P. Gaebler, Y. Lin, Y. Wan, R. Bowler, D. Leibfried, and D. J. Wineland, Multi- Element Logic Gates for Trapped-Ion Qubits, Nature (London) 528, 380 (2015).
[6] J. J. L. Morton et al., Solid-State Quantum Memory Using the ³¹P Nuclear Spin, Nature (London) 455, 1085 (2008).
[7] F. Arute et al., Quantum Supremacy Using a Programmable Superconducting Processor, Nature (London) 574, 505 (2019).
[8] J. J. Pla, K. Y. Tan, J. P. Dehollain, W. H. Lim, J. J. L. Morton, F. A. Zwanenburg, D. N. Jamieson, A. S. Dzurak, and A. Morello, High-Fidelity Readout and Control of a Nuclear Spin Qubit in Silicon, Nature (London) 496, 334 (2013)
[9] F. A. Zwanenburg, A. S. Dzurak, A. Morello, M. Y. Simmons, L. C. L. Hollenberg, G. Klimeck, S. Rogge, S. N. Coppersmith, and M. A. Eriksson, Silicon Quantum Electronics, Rev. Mod. Phys. 85, 961 (2013).
[10] C. E. Bradley, J. Randall, M. H. Abobeih, R. C. Berrevoets, M. J. Degen, M. A. Bakker, M. Markham, D. J. Twitchen, and T. H. Taminiau, A Ten-Qubit Solid-State Spin Register with Quantum Memory up to One Minute, Phys. Rev. X 9, 031045 (2019).
[11] P. O. Schmidt, T. Rosenband, C. Langer, W. M. Itano, J. C. Bergquist, and D. J. Wineland, Spectroscopy Using Quantum Logic, Science 309, 749 (2005).
[12] C. D. Bruzewicz, J. Chiaverini, R. McConnell, and J. M. Sage, Trapped-Ion Quantum Computing: Progress and Challenges, Appl. Phys. Rev. 6, 021314 (2019).
[13] I. V. Inlek, C. Crocker, M. Lichtman, K. Sosnova, and C. Monroe, Multispecies Trapped-Ion Node for Quantum Networking, Phys. Rev. Lett. 118, 250502 (2017).
[14] S. Ebadi et al., Quantum Phases of Matter on a 256-Atom Programmable Quantum Simulator, Nature (London) 595, 227 (2021)
[15] P. Scholl et al., Quantum Simulation of 2D Antiferromagnets with Hundreds of Rydberg Atoms, Nature (London) 595, 233 (2021).
[16] A. W. Young, W. J. Eckner, W. R. Milner, D. Kedar, M. A. Norcia, E. Oelker, N. Schine, J. Ye, and A. M. Kaufman, Half-Minute-Scale Atomic Coherence and High Relative Stability in a Tweezer Clock, Nature (London) 588, 408 (2020).
[17] I. S. Madjarov et al., High-Fidelity Entanglement and Detection of Alkaline-Earth Rydberg Atoms, Nat. Phys. 16, 857 (2020)
[18] H. Levine et al., Parallel Implementation of High-Fidelity Multiqubit Gates with Neutral Atoms, Phys. Rev. Lett. 123, 170503 (2019).
[19] T. M. Graham, M. Kwon, B. Grinkemeyer, Z. Marra, X. Jiang, M. T. Lichtman, Y. Sun, M. Ebert, and M. Saffman, Rydberg-Mediated Entanglement in a Two-Dimensional Neutral Atom Qubit Array, Phys. Rev. Lett. 123, 230501 (2019).
[20] A. Omran et al., Generation and Manipulation of Schrödinger Cat States in Rydberg Atom Arrays, Science 365, 570 (2019).
[21] M. Saffman, Quantum Computing with Atomic Qubits and Rydberg Interactions: Progress and Challenges, J. Phys. B 49, 202001 (2016).
[22] D. Ohl de Mello, D. Schaffner, J. Werkmann, T. Preuschoff, L. Kohfahl, M. Schlosser, and G. Birkl, Defect-Free Assembly of 2D Clusters of More Than 100 Single-Atom Quantum Systems, Phys. Rev. Lett. 122, 203601 (2019).
[23] G. Semeghini et al., Probing Topological Spin Liquids on a Programmable Quantum Simulator, Science 374, 1242 (2021).
[24] S. de Léséleuc, V. Lienhard, P. Scholl, D. Barredo, S. Weber, N. Lang, H. P. Bchler, T. Lahaye, and A. Browaeys, Observation of a Symmetry-Protected Topological Phase of Interacting Bosons with Rydberg Atoms, Science 365, 775 (2019).
[25] A. Browaeys and T. Lahaye, Many-Body Physics with Individually Controlled Rydberg Atoms, Nat. Phys. 16, 132 (2020).
[26] M. Morgado and S. Whitlock, Quantum Simulation and Computing with Rydberg-Interacting Qubits, AVS Quantum Sci. 3, 023501 (2021).
[27] J. M. Auger, S. Bergamini, and D. E. Browne, Blueprint for Fault-Tolerant Quantum Computation with Rydberg Atoms, Phys. Rev. A 96, 052320 (2017)
[28] A. G. Fowler, M. Mariantoni, J. M. Martinis, and A. N. Cleland, Surface Codes: Towards Practical Large-Scale Quantum Computation, Phys. Rev. A 86, 032324 (2012).
[29] C. L. Degen, F. Reinhard, and P. Cappellaro, Quantum Sensing, Rev. Mod. Phys. 89, 035002 (2017).
[30] A. W. Glaetzle, R. M. W. van Bijnen, P. Zoller, and W. Lechner, A Coherent Quantum
   Annealer with Rydberg Atoms, Nat. Commun. 8, 15813 (2017).
[31] I. I. Beterov and M. Saffman, Rydberg Blockade, Förster Resonances, and Quantum State Measurements with Different Atomic Species, Phys. Rev. A 92, 042710 (2015).
[32] R. V. Brooks, S. Spence, A. Guttridge, A. Alampounti, A. Rakonjac, L. A. McArd, J. M. Hutson, and S. L. Cornish, Preparation of One ⁸⁷Rb and One ¹³³Cs Atom in a Single Optical Tweezer, New J. Phys. 23, 065002 (2021).
[33] D. Kim, A. Keesling, A. Omran, H. Levine, H. Bernien, M. Greiner, M. D. Lukin, and D. R. Englund, Large-Scale Uniform Optical Focus Array Generation with a Phase Spatial Light Modulator, Opt. Lett. 44, 3178 (2019).
[34] M. L. Harris, P. Tierney, and S. L. Cornish, Magnetic Trapping of a Cold Rb—Cs Atomic Mixture, J. Phys. B 41, 035303 (2008).
[35] C. Weber, S. John, N. Spethmann, D. Meschede, and A. Widera, Single Cs Atoms as Collisional Probes in a Large Rb Magneto-Optical Trap, Phys. Rev. A 82, 042722 (2010).
[36] N. Schlosser, G. Reymond, I. Protsenko, and P. Grangier, Sub-Poissonian Loading of Single Atoms in a Microscopic Dipole Trap, Nature (London) 411, 1024 (2001).
[37] M. Endres et al., Atom-by-Atom Assembly of Defect-Free One-Dimensional Cold Atom Arrays, Science 354, 1024 (2016).
[38] S. Notarnicola, M. Collura, and S. Montangero, Real-Time-Dynamics Quantum Simulation of (1+1)-Dimensional Lattice QED with Rydberg Atoms, Phys. Rev. Research 2, 013288 (2020).
[39] R. Guo et al., Balanced Coherence Times of Atomic Qubits of Different Species in a Dual 3×3 Magic-Intensity Optical Dipole Trap Array, Phys. Rev. Lett. 124, 153201 (2020).
[40] C. Sheng et al., Defect-Free Arbitrary-Geometry Assembly of Mixed-Species Atom Arrays, Phys. Rev. Lett. 128, 083202 (2022).
[41] L. R. Liu, J. D. Hood, Y. Yu, J. T. Zhang, N. R. Hutzler, T. Rosenband, and K.-K. Ni, Building One Molecule from a Reservoir of Two Atoms, Science 360, 900 (2018).
[42] M. Muller, I. Lesanovsky, H. Weimer, H. P. Buchler, and P. Zoller, Mesoscopic Rydberg Gate

Based on Electromagnetically Induced Transparency, Phys. Rev. Lett. 102, 170502 (2009).
[43] D. Barredo, S. de Léseleuc, L. Vincent, L. Thierry, and B. Antoine, An Atom-by-Atom Assembler of Defect-Free Arbitrary Two-Dimensional Atomic Arrays, Science 354, 1021 (2016).
[44] H. Kim, W. Lee, H.-G. Lee, H. Jo, Y. Song, and J. Ahn, In Situ Single-Atom Array Synthesis Using Dynamic Holographic Optical Tweezers, Nat. Commun. 7, 13317 (2016).
[45] Y. R. P. Sortais et al., Diffraction-Limited Optics for Single-Atom Manipulation, Phys. Rev. A 75, 013406 (2007).
[46] C. Tuchendler, A. M. Lance, A. Browaeys, Y. R. P. Sortais, and P. Grangier, Energy Distribution and Cooling of a Single Atom in an Optical Tweezer, Phys. Rev. A 78, 033425 (2008).
[47] H. Levine et al., Dispersive Optical Systems for Scalable Raman Driving of Hyperfine Qubits, arXiv: 2110.14645
[48] J. P. Covey, I. S. Madjarov, A. Cooper, and M. Endres, 2000-Times Repeated Imaging of Strontium Atoms in Clock-Magic Tweezer Arrays, Phys. Rev. Lett. 122, 173201 (2019).
[49] K.-N. Schymik, S. Pancaldi, F. Nogrette, D. Barredo, J. Paris, A. Browaeys, and T. Lahaye, Single Atoms with 6000-Second Trapping Lifetimes in Optical-Tweezer Arrays at Cryogenic Temperatures, Phys. Rev. Applied 16, 034013 (2021).

What is claimed is:

1. A system for generating a multi-element atom array, comprising:
a first spatial light modulator configured to transform a first input laser beam into a first spatially modulated laser beam, the first input laser beam having a first wavelength;
a second spatial light modulator configured to transform a second input laser beam into a second spatially modulated laser beam, the second input laser beam having a second wavelength different from the first wavelength;
a beam combiner configured to combine the first and second spatially modulated laser beams into a combined laser beam; and
a focusing lens configured to focus the combined laser beam.

2. The system of claim 1, the beam combiner comprising a polarized beamsplitter or dichroic mirror.

3. The system of claim 1, the focusing lens comprising a microscope objective.

4. The system of claim 1, the focusing lens having a numerical aperture of 0.5 of more.

5. The system of claim 1, wherein each of the first and second spatial light modulators is a liquid-crystal modulator or an acousto-optic deflector.

6. The system of claim 1, further comprising one or both of:
a first spatial filter between the first spatial light modulator and the beam combiner; and
a second spatial filter between the second spatial light modulator and the beam combiner.

7. The system of claim 1, the focusing lens being configured to focus the combined laser beam through a vacuum window or a wall of a glass cell.

8. The system of claim 1, further comprising an imaging lens configured to image the combined laser beam, after being focused by the focusing lens, onto a camera.

9. The system of claim 8, further comprising the camera.

10. The system of claim 9, the camera comprising a charge-coupled device (CCD) camera.

11. The system of claim 1, further comprising a vacuum cell positioned such that a focus of the combined laser beam occurs within the vacuum cell.

12. The system of claim 1, further comprising one or both of:
a first laser configured to generate the first input laser beam; and
a second laser configured to generate the second input laser beam.

13. The system of claim 1, further comprising a dichroic mirror positioned between the beam combiner and the focusing lens, the dichroic mirror being oriented to reflect light from the focusing lens away from the beam combiner.

14. The system of claim 1, further comprising:
a first controller configured to control the first spatial light modulator such that the first spatially modulated laser beam, after being focused by the focusing lens, forms a first plurality of optical tweezers; and
a second controller configured to control the second spatial light modulator such that the second spatially modulated laser beam, after being focused by the focusing lens, forms a second plurality of optical tweezers that do not spatially overlap the first plurality of optical tweezers.

15. A method for generating a multi-element atom array, comprising:
operating the first spatial light modulator of the system of claim 1 to generate a first plurality of optical tweezers at the first wavelength; and
operating the second spatial light modulator of the system of claim 1 to generate a second plurality of optical tweezers at the second wavelength;
wherein the second plurality of optical tweezers do not spatially overlap the first plurality of optical tweezers.

16. The method of claim 15, each of the first and second pluralities of optical tweezers forms an optical-tweezer array.

17. The method of claim 15, further comprising:
trapping atoms of a first atomic element into the first plurality of optical tweezers; and
trapping atoms of a second atomic element into the second plurality of optical tweezers, the second atomic element being different than the first atomic element.

18. The method of claim 17, each of the first and second atomic elements being selected from the group consisting of alkali metals and alkaline-earth metals.

19. The method of claim 17, further comprising one or both of:
collecting fluorescence only from the atoms of the first atomic element while (i) the atoms of the first atomic element are trapped in the first plurality of optical tweezers and (ii) the atoms of the second atomic element are trapped in the second plurality of optical tweezers; and
collecting fluorescence only from the atoms of the second atomic element while (i) the atoms of the first atomic element are trapped in the first plurality of optical tweezers and (ii) the atoms of the second atomic element are trapped in the second plurality of optical tweezers.

20. The method of claim 15, further comprising one or both of:
homogenizing intensities of the first plurality of optical tweezers; and
homogenizing intensities of the second plurality of optical tweezers.
